(19) United States
(12) Patent Application Publication
(10) Pub. No.: US 2008/0093354 A1
(43) Pub. Date: Apr. 24, 2008

(54) Electro-thermal vest

(75) Inventors: Jim Fang, Xiaoshan Economy-Technology Development (CN); Kiff Chen, Xiaoshan Economy-Technology Development (CN); Haiyan Wu, Xiaoshan Economy-Technology Development (CN)

Correspondence Address: BIRCH STEWART KOLASCH & BIRCH, PO BOX 747, FALLS CHURCH, VA, 22040-0747, US

(73) Assignee: Hangzhou Acepower Electronics Co., Ltd

(21) Appl. No.: 11/808,080

(22) Filed: Jun. 6, 2007

(30) Foreign Application Priority Data
Oct. 18, 2006 (CN) 200620108786.X

(51) Int. Cl. H05B 1/00

(52) U.S. Cl. 219/211

(57) ABSTRACT

An electro-thermal vest of the invention includes an outer lining layer, an inner lining layer, an electro-thermal element and a combining element. The inner lining layer has a first lining and a second lining. The electro-thermal element is fixed on the second lining and disposed between the first lining and the second lining. The combining element detachably combines the inner lining layer with the outer lining layer.

### BACKGROUND OF THE INVENTION

1. Field of Invention

The invention relates to a garment, and, in particular, to an electro-thermal garment.

2. Related Art

An electro-thermal garment usually contains an electrothermal element driven by a power source so as to produce heat for defending against the cold.

The conventional electro-thermal garment includes an inner lining layer, an electro-thermal element and an outer lining layer. The inner and outer lining layers are the inside and outside of the electro-thermal garment. The electro-thermal element is sewed on the inner lining layer. The outer lining layer covers the electrothermal element and it is sewed with the inner lining layer. So the electro-thermal element is fixed between the inner and outer lining layers. In this case, the inner lining layer, the outer lining layer and the electro-thermal element are combined together and can not be detached.

Because the outer lining layer is usually exposed in the outside environment, this part gets dirty easily. Thus, the user needs to clean it frequently. However, the user can not separate the outer lining layer from the inner lining layer and the electro-thermal element, and it is forbidden to wash the electro-thermal element by water. That is, it is not convenient to clean the electro-thermal garment.

In addition, the conventional electro-thermal garment further includes a battery module. The battery module supplies power to the electro-thermal element such that the electro-thermal element can be driven to produce heat.

In general, the battery module includes hydrocarbon battery, alkaline battery, or NiH battery for supplying steady DC power to drive the electro-thermal element. However, the lifetime of the alkaline battery or NiH battery is short, and the battery module has constant outputs, so that the electro-thermal element will generate constant heat and can not provide the temperature adjusting function. Therefore, the conventional electro-thermal garment can not satisfy user's needs.

Thus, it is an important subject of the invention to provide an electro-thermal vest which can be disassembled and cleaned easily and is temperature adjustable, heating fast and steady, and safe.

### SUMMARY OF THE INVENTION

In view of the foregoing, the invention is to provide a detachable electro-thermal vest.

To achieve the above, an electro-thermal vest of the invention includes an outer lining layer, an inner lining layer, an electro-thermal element and a combining element. The inner lining layer has a first lining and a second lining. The electro-thermal element is fixed on the second lining and disposed between the first lining and the second lining. The combining element detachably combines the inner lining layer with the outer lining layer.

As mentioned above, in the electrothermal vest of the invention, the combining element detachably combines the inner lining layer with the outer lining layer. Thus the user can disassemble the outer lining layer from the inner lining layer, so that the outer lining layer, which gets dirty easier, can be washed or maintained separately.

### BRIEF DESCRIPTION OF THE DRAWINGS

The invention will become more fully understood from the detailed description given herein below illustration only, and thus is not limitative of the present invention, and wherein:

FIGS. 1 to 3 are exploded views showing an electro-thermal vest according to a preferred embodiment of the invention;

FIG. 4 is a block diagram showing the electro-thermal vest according to the preferred embodiment of the invention; and

FIG. 5 is a schematic illustration showing the assembled electro-thermal vest according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

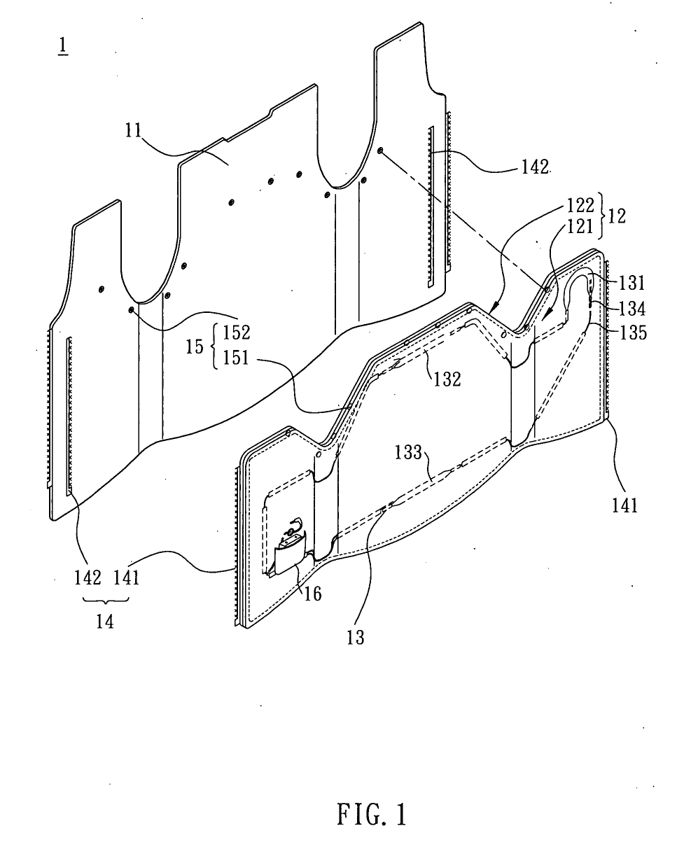

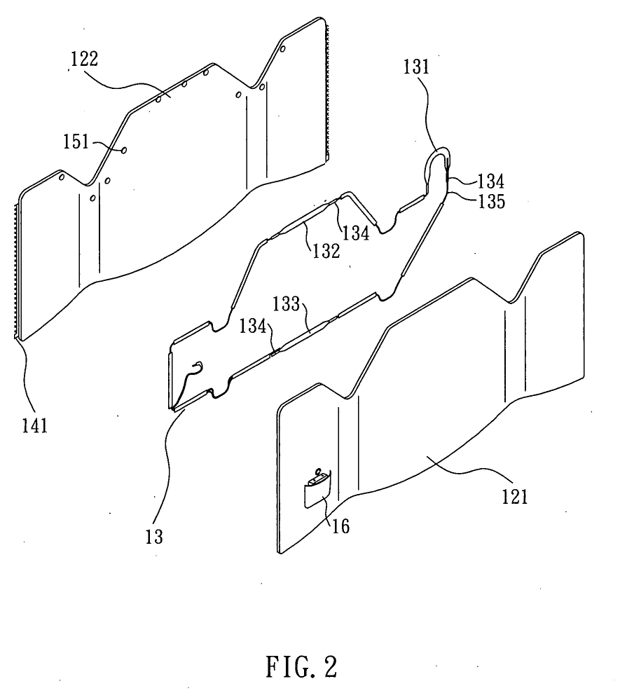

Referring to FIG. 1 and FIG. 2, an electro-thermal vest 1 according to a preferred embodiment of the invention includes an outer lining layer 11, an inner lining layer 12, an electro-thermal element 13 and a plurality of combining elements 14 and 15. FIG. 1 depicts that the outer lining layer 11 and the inner lining layer 12 are disassembled. FIG. 2 depicts that the inner lining layer 12 and the electro-thermal element 13 are disassembled. The inner lining layer 12 has a first lining 121 and a second lining 122. The electro-thermal element 13 is fixed on the second lining 122 and disposed between the first lining 121 and the second lining 122. The combining elements 14 and 15 detachably combine the inner lining layer 12 with the outer lining layer 11.

After the inner lining layer 12 is combined with the outer lining layer 11, a user can wear the electrothermal vest 1. In this case, the first lining 121 directly contacts with the user or interlaid with clothes of the user, and the outer lining layer 11 is exposed outside.

The combining element 14 includes a first part 141 and a second part 142. The first part 141 is fixed on the inner lining layer 12. For example, the first part 141 may be sewed between the first lining 121 and the second lining 122. The second part 142 is fixed on the outer lining layer 11. The combining element 15 includes a first part 151 and a second part 152. The first part 151 is fixed on the inner lining layer 12. For example, the first part 151 may be sewed between the first lining 121 and the second lining 122. The second part 152 is fixed on the outer lining layer 11. In this case, the second parts 142 and 152 detachably assemble with the first parts 141 and 151, respectively, to combine the inner lining layer 12 with the outer lining layer 11. In this manner, the user can easily disassemble/assemble the inner lining layer 11 and the outer lining layer 12 in need.

In the embodiment, the combining element 14 is a zipper. The first part 141 and the second part 142 are two sides of the zipper fixed in the end flaps of the second lining 122 and the outer lining layer 11 respectively. In addition, the combining element 15 is a button pair. The first part 151 is a buttonhole located in a collar of the second lining 122, and the second part 152 is a button fixed on a collar of the outer lining layer 11. The first part 151 and the second part 152 are located corresponding to each other such that the user can button the second part 152 with the first part 151.

Alternatively, the connection between the inner lining layer 12 and the outer lining layer 11 can utilize the zips located at the end flap and the collar. To be noted, the combining elements 14 and 15 can be any possible means, such as Velcro. Moreover, the connection may be implemented by button pairs, velcroes, or combinations of the zip, button pair and Velcro.

Generally speaking, the inner lining layer 12 and the outer lining layer 11 are detachably bound together, so that they can be disassembled easily for separately cleaning. In detailed, the electro-thermal vest 1 can be disassembled easily, and the outer lining layer 11 can be separately washed and dried.

The outer lining layer 11 is breathable, so that the user will feel more comfortable when wearing it. Moreover, the outer lining layer 11 is waterproof, and it protects the user and the electric elements of the electro-thermal vest 1 from getting wet.

Referring to FIG. 2, the electrothermal element 13 includes three heating silks 131 to 133, a plurality of protecting sheathes 134 and a plurality of electronic wires 135. Each protecting sheath 134 coves a junction of each electronic wire 135 and corresponding one of the heating silks 131 to 133. The heating silks 131 to 133 are sewed on or adhered to the second lining 122. These three heating silks 131 to 133 are connected in series via the electronic wires 135. Two terminals of the above mentioned circuitry are electrically connected with the power module 16.

The heating silks 131 to 133 are respectively located at a left chest portion, a top-back portion and a bottom-back portion of the inner lining layer 12. In the embodiment, the heating silks 131 to 133 are made of carbon fiber, and they heat steadily. The resistance of the heating silks 131 to 133 is preferably between 3.3 to 6Ω, and, in this embodiment, the resistance of the heating silks 131 to 133 is 6Ω.

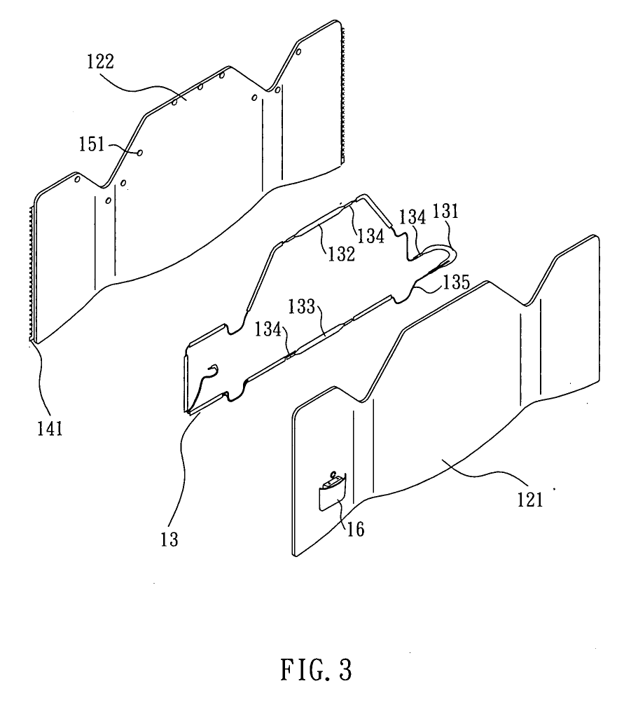

Referring to FIG. 3, in another embodiment, the heating silk 131 is located at a left abdomen portion of the inner lining layer 12.

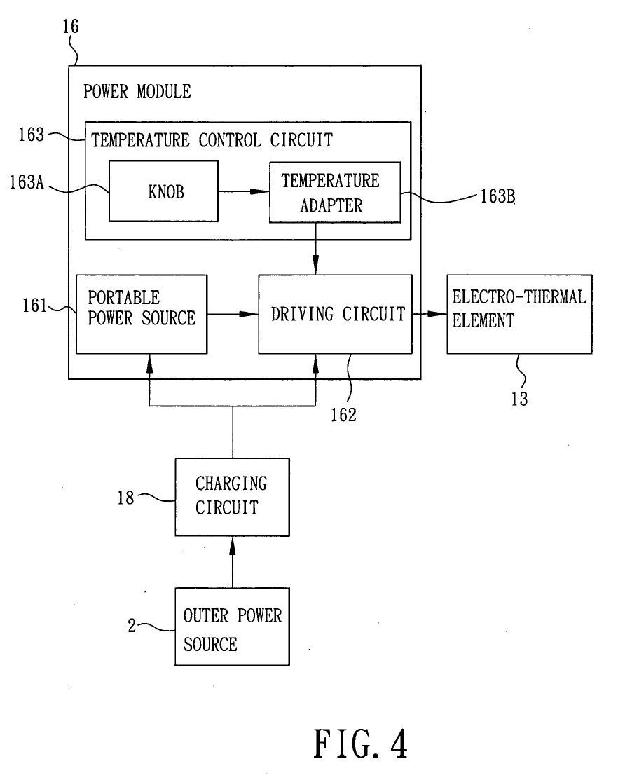

Referring to FIG. 4, the power module 16 includes a portable power source 161, a driving circuit 162 and a temperature control circuit 163. The driving circuit 162 is coupled with the portable power source 161 and the electro-thermal element 13 to drive the electro-thermal element 13 to heat.

The portable power source 161 is a DC battery source. The DC battery source is, for example, a lithium battery, which has the advantage of long lifetime, zero electromagnetic wave, zero radiation and safe usage. Preferably, the lithium battery may be of the same quality as that used in a notebook.

The portable power source 161 may be further coupled with a charging circuit 18 such as a charge transformer. The charging circuit 18 coupled with an outer power source 2 is used to charging the portable power source 161. The range of the input voltage of the charging circuit 18 is roughly between 100-240 Volts, so that the portable power source 161 can be charged full about 3 hours.

In addition, the charging circuit 18 is an AC-DC transformer coupled with the driving circuit 162 to supply power. The charging circuit 18 can directly drive the electro-thermal element 13 to heat. By this way, either one of the portable power source 161 and the outer power source 2 can drive the electro-thermal element 13 to heat directly.

The temperature control circuit 163 is coupled with the driving circuit 162 and senses the temperature of the electro-thermal element 13 to control the driving circuit 162 to drive the electro-thermal element 13. Accordingly, the temperature of the electrothermal element 13 can be adjusted by the temperature control circuit 163.

In addition, the temperature control circuit 163 further determines whether the temperature of the electro-thermal element 13 is higher than a predetermined temperature or not, and thus controls the driving circuit whether to drive the electro-thermal element to heat. In this mechanism, if the temperature of the electro-thermal element 13 is too high, and then the temperature control circuit 163 will stop driving the electro-thermal element 13. Therefore, the electro-thermal element 13 can be well protected.

In the embodiment, the temperature control circuit 13 includes a knob 163A and a temperature adapter 163B to control the current or voltage outputted from the driving circuit 162 to the electro-thermal element 13, so as to control the heating temperature of the electro-thermal element 13.

For example, the temperature adapter 163B has a temperature control setting with five scales corresponding to warm, medium, mild, high, and extra high temperatures. The warm to extra high temperatures are from 38 to 67° C. Therefore, the user can adjust temperature control setting in need. The knob 163A is coupled with the temperature adapter 163B, and the user can adjust the temperature control setting by tuning the knob 163A. The extra high temperature is usually applied for healing convulsion resulting from tiredness and tension of muscle, and easing ache, arthritis, and rheumatism, etc. That is, the extra high temperature can be a therapy for some illness of our bodies. After wearing in the extra high temperature for about 10 minutes, the user feels a little numb like acupuncture and moxibustion. After holding the numbness for about 2 minutes, the user should tunes the knob 163A into the mild temperature. When the user feels the temperature is cooled down, he or she may tune the knob 163A back to the extra high temperature. If the user repeats these procedures several times per day, he or she will be healthier and stronger.

In addition, when the temperature control circuit 163 detects that the temperature of the electro-thermal element 13 is too high, it controls the output current or voltage from the driving circuit 162. Therefore, the electro-thermal element 13 is driven by the adjusted current or voltage so as to adjust and control the temperature. This mechanism can achieve the goal of preventing over-heating automatically for safe usage.

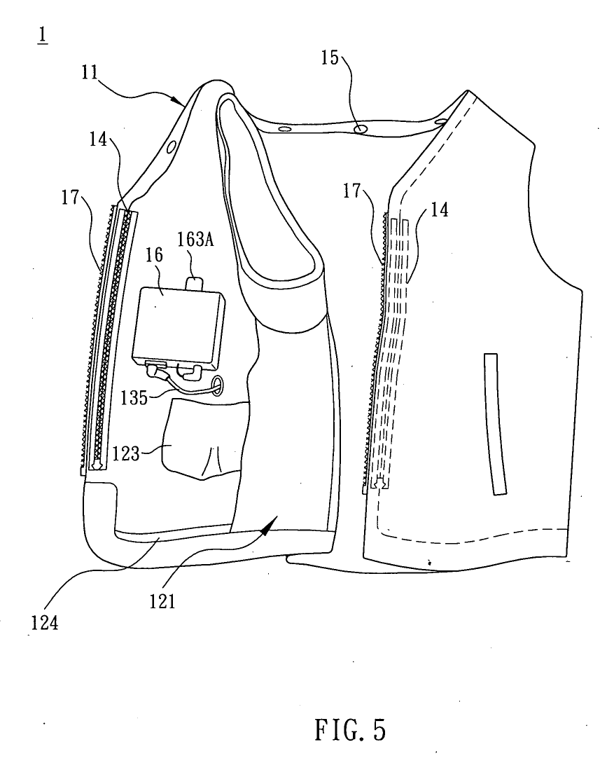

FIG. 5 depicts the assembled of the outer lining layer 11 and the inner lining layer 12 of the electro-thermal vest 1. Referring to FIG. 5, the user can put on the underwear first, and then put on the electro-thermal vest 1. The two sides of the inner lining layer 12 of the electro-thermal vest 1 can be made of high-tension elastic cloth, so the electro-thermal vest 1 can fit the user's body. Thus the user feels more comfortable when wearing the electro-thermal vest 1. Furthermore, a zipper 17 is disposed in the end flaps of the outer lining layer 11 of the electrothermal vest 1. The user can zip the zipper 17 to keep the heat. The zipper 17 may be an invisible zipper. Thus, the zipped zipper 17 is not obvious, and the appearance of the electro-thermal vest 1 will be more beautiful. Of course, the user can put on the electro-thermal vest 1 without zipping the zipper 17. By employing the high-tension elastic cloth and the invisible zipper, the electro-thermal vest 1 is suitable for the user of any size.

The power module 16 is placed in the pocket 123 of the electro-thermal vest 1, and the power input plug of the electronic wire 135 is plugged into a charge socket of the power module 16. Then the temperature sensing connecter in the pocket 123 is plugged into a temperature sensing socked of the power module 16. After the connection is completed, the user can turn on the power module 16. The temperature control circuit 163 has a knob 163A for adjusting the temperature control setting. The user can tune the knob 163A to one of the five scales in need, and put the power module 16 into the pocket 123 of the electro-thermal vest 1. Then he or she can move freely without restricted by the power line.

As mentioned above, in the electro-thermal vest of the invention, the combining element detachably combines the inner lining layer with the outer lining layer. Thus the user can remove the outer lining layer from the inner lining layer to separately clean the outer lining layer.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An electro-thermal vest, comprising:
an outer lining layer;
an inner lining layer having a first lining and a second lining;
an electro-thermal element fixed on the second lining and disposed between the first lining and the second lining; and
a combining element detachably combining the inner lining layer with the outer lining layer.

2. The electro-thermal vest as recited in claim 1, wherein the combining element comprises:
a first part fixed on the inner lining layer; and
a second part fixed on the outer lining layer, wherein the second part detachably assembles with the first part to combine the inner lining layer with the outer lining layer.

3. The electro-thermal vest as recited in claim 2, wherein the first part of the combining element is fixed on an end flap of the inner lining layer, and the second part of the combining element is fixed on an end flap of the outer lining layer.

4. The electro-thermal vest as recited in claim 2, wherein the first part of the combining element is fixed on a collar of the inner lining layer, and the second part of the combining element is fixed on a collar of the outer lining layer.

5. The electro-thermal vest as recited in claim 2, wherein the combining element is a zipper, a button pair or a velcro.

6. The electro-thermal vest as recited in claim 1, wherein the outer lining layer is waterproof or breathable.

7. The electro-thermal vest as recited in claim 1, wherein the electro-thermal element comprises:
a plurality of electronic wires; and
three heating silks connected to the electronic wires in series, wherein two of the heating silks are respectively located at a top-back portion and a bottom-back portion of the inner lining layer, and the other one of the heating silks is located at a left chest portion or a left abdomen portion.

8. The electro-thermal vest as recited in claim 1, wherein the electro-thermal element comprises:
a heating silk made of carbon fiber.

9. The electro-thermal vest as recited in claim 1, wherein the electro-thermal element comprises:
an electronic wire;
a heating silk connected to the electric wire; and
a protecting sheath covering a junction of the electronic wire and the heating silk.

10. The electrothermal vest as recited in claim 1, further comprising:
a power module having a portable power source and a driving circuit, wherein the driving circuit is coupled with the portable power source and the electro-thermal element to drive the electro-thermal element to heat.

11. The electro-thermal vest as recited in claim 10, wherein the portable power source is a lithium battery.

12. The electro-thermal vest as recited in claim 10, wherein the power module further comprises:
a temperature control circuit coupled with the driving circuit and sensing the temperature of the electro-thermal element to control the driving circuit to, drive the electro-thermal element so as to adjust the temperature of the electro-thermal element.

13. The electro-thermal vest as recited in claim 12, wherein the temperature control circuit comprises:
a temperature adapter having a temperature control setting with five scales corresponding to warm, medium, mild, high, and extra high temperatures to adjust the temperature of the electro-thermal element.

14. The electro-thermal vest as recited in claim 13, wherein the temperature control circuit comprises:
a knob coupled with the temperature adapter to adjust the temperature control setting.

15. The electro-thermal vest as recited in claim 12, wherein the temperature control circuit determines whether the temperature of the electro-thermal element is higher than a predetermined temperature or not, and thus controls the driving circuit continue whether to drive the electrothermal element to heat.

16. The electro-thermal vest as recited in claim 10, wherein a charging circuit is used to charging the portable power source.

17. The electrothermal vest as recited in claim 10, wherein the power module further comprises:
a charging circuit coupled with an outer power source to supply power to the driving circuit and the electro-thermal element.

18. The electro-thermal vest as recited in claim 10, wherein the inner lining layer further comprises a pocket and the power module is placed in the pocket.

19. The electrothermal vest as recited in claim 1, further comprising:
a zipper fixed on an end flap of the outer lining layer.

20. The electro-thermal vest as recited in claim 19, wherein the zipper is an invisible zipper.
